(19) United States
(12) Patent Application Publication
(10) Pub. No.: US 2015/0160409 A1
(43) Pub. Date: Jun. 11, 2015

(54) METHOD OF FABRICATING A FIBRE DEVICE

(71) Applicants: Agency for Science, Technology and Research, Singapore (SG); Nanyang Technological University, Singapore (SG)

(72) Inventors: Yicheng Lai, Singapore (SG); Feng Luan, Singapore (SG)

(21) Appl. No.: 14/565,083

(22) Filed: Dec. 9, 2014

(30) Foreign Application Priority Data
Dec. 9, 2013 (SG) 201309112-9

(51) Int. Cl. G02B 6/02

(52) U.S. Cl. CPC G02B 6/02123; G02B 2006/02161

(57) ABSTRACT

Various embodiments provide a method of fabricating a fibre, the method comprising translating a fibre having a light transmissive core surrounding by a cladding material; and while translating, non-interferometrically applying energy to alter structure of the light transmissive core and/or the cladding material.

### PRIORITY CLAIM

The present application claims priority to Singapore Patent Application No. 201309112-9, filed on 9 Dec. 2013.

### FIELD OF THE INVENTION

Embodiments of the present invention relate to methods for fabricating a fibre device, for example an optical fibre device. In particular, it relates to a method of fabricating a fibre device based on pulse laser technology with a continuous, high-volume fibre translation system.

### BACKGROUND

Methodology of fabricating large scale fibre or optical fibre devices are widely used to enable large number (100s to 1000s) of fibre devices to be created into a continuous, slice-free, long length (e.g., metres to kilometres) of fibre as the fibre is being translated or manufactured. In some applications, for example, remote acoustic and temperature sensing in oil and gas industries, such long array of fibre devices provide the required form factor as well as high performance solutions desired (e.g., high spatial resolution, immunity to electromagnetic interference etc).

Conventionally, there are two main techniques to achieve high-volume and cost effective fibre device fabrication. There are (a) Fibre Bragg grating (FBG) inscription on a fibre draw tower system and (b) Reel-to-reel FBG inscription with automated fibre stripping and recoating. However, each of these two techniques has its own shortcomings.

For the first conventional technique (i.e., FBG inscription on a fibre draw tower system), pre-fabrication and post fabrication treatment processes are required to enable these fibre devices to operate beyond 300 degree Celsius. Also, it is necessary to carry out a grating inscription process prior to a coating process to ensure that the fibre is not subjected to any damaging effects that usually arise from coating removal. Conventionally, it is possible to inscribe single-pulse FBG gratings with minimum grating separation of approximately 10 millimetres while the ultraviolet interferometry optical arrangement allows operation wavelength tuning over hundreds of nanometres of the grating inscribed. Moreover, the conventional technique, that is based on UV laser inscription, is dependent on the material of the fibre used (e.g., the fibre material should be photosensitive).

For the second conventional technique (i.e., reel-to-reel FBG inscription with automated fibre stripping and recoating), it generally involves a material-dependent process of chemical or mechanical stripping of fibre coating prior to the FBG inscriptions so as to fabricate fibre devices. However, pre-inscription processes and fibre handling techniques tend to be complex for reel-to-reel FBG inscription as it involves thorough cleaning of the fibre prior to the ultraviolet laser inscription process. This approach hence involves non-conventional modification and add-on to a fibre spooler (or rewinder) system though the system can remain compact and less sophisticated than that of a draw tower system.

However, the reel-to-reel FBG inscription offers many advantages over the FBG inscription on a fibre draw tower system in terms of flexibility in the grating inscription process. Unlike the fibre draw tower system, an inscription beam translates pass a fibre at a more flexible speed when the reel-to-reel FBG inscription is used, enabling a greater variety of grating structures to be realized. On the other hand, velocity of the fibre translation on the draw tower system general cannot be varied greatly as it compromises the resultant fibre structure itself.

It is against this background that the present invention has been developed.

### SUMMARY OF INVENTION

Various embodiments provide a method of fabricating a fibre, the method comprising translating a fibre having a light transmissive core surrounding by a cladding material; and while translating, non-interferometrically applying energy to alter structure of the light transmissive core and/or the cladding material.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 depicts a schematic diagram broadly illustrating an exemplary system according to an embodiment of the present invention.

FIG. 2 depicts a simplified diagram illustrating complex structures in the fibre according to the embodiment shown in FIG. 1.

FIG. 3A depicts a simplified diagram illustrating distributed waveguides in the fibre according to a first embodiment.

FIG. 3B depicts a simplified diagram illustrating an additional waveguide in the fibre according to a second embodiment.

FIG. 3C depicts a cross-sectional view of additional waveguides in the fibre according to a third embodiment.

FIG. 3D depicts a simplified diagram depicting the additional waveguides in the fibre of FIG. 3C.

FIG. 4 depicts a simplified diagram illustrating how to perform laser inscription according to a conventional technique.

FIG. 5 depicts a simplified diagram illustrating how to perform laser inscription according to an embodiment of the present invention.

FIG. 6 depicts a sample grating result achieved on the fibre according to the conventional technique shown in FIG. 4.

FIG. 7 depicts a sample grating result achieved on the fibre according to the embodiment shown in FIG. 5.

### DETAILED DESCRIPTION

Various embodiments relate to methods of fabricating a fibre device. A person skilled in the art will understand that a fibre, for example an optical fibre, includes a light transmissive core (or a fibre core) and a cladding material surrounding the core. Also, it is to be understood that a fibre device is a modification inscribed or done on a fibre. A modification includes a grating or a waveguide.

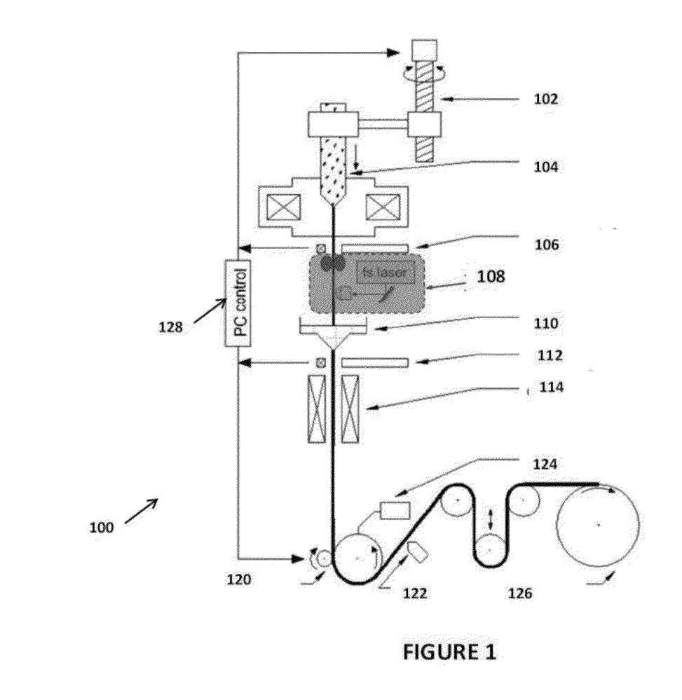

FIG. 1 is a schematic diagram broadly illustrating an exemplary system 100 according to an embodiment of the present invention. The system 100 allows fabricating a fibre device by translating a fibre having a light transmissive core surrounding by a cladding material and, while translating, non-interferometrically applying energy to alter structure of the light transmissive core and/or the cladding material.

The system 100 comprises a preform infeed 102, a preform 104, a first measuring unit 106 for measuring a diameter of the fibre, a pulse laser 108, a coating unit 110, a second measuring unit 112 for measuring a concentricity of the fibre, a drying unit 114, a movable means 116 in communication with a third measuring unit 124 for measuring a length of the fibre, a marker 122 for the fibre and a winding means 126 for winding the fibre onto a reel. In an embodiment, the marker 122 is suitable for measuring a position of the fibre.

Referring to FIG. 1, the first measuring unit 106 and the second measuring unit 112 are in communication with a pc control (or processor) 128 to provide the measurements of the diameter, the concentricity and position of the fibre. According to an embodiment of the present invention, in order to substantially avoid, or at least minimise, misalignment of the gratings inscribed by the pulse laser 108, the focusing condition and position of the pulse laser setup 108 is configured to translate or to rotate or turn about its own or about the fibre axis. Advantageously, such control of the pulse light 108 (which can be focused) acts to inscribe gratings in the core of the fibre in response to the measurement detected by the first measuring unit 106. In an embodiment, the pulse light 108 includes a focusing lens and a camera system. The focusing lens setup in the pulse light 108 coupled with the camera system can enable high-magnification view of the position of the laser inscription within the fibre core. Similarly, the focusing condition and position of the pulse light 108 can be configured to translate or to rotate or to turn about its own or about the fibre axis to avoid misalignment of the grating inscription process.

For example, the pulse light 108 has an axis that is generally perpendicular to a longitudinal axis of the fibre fed through the preform 104. According to an embodiment of the present invention, in order to inscribe gratings substantially transverse to a core of the fibre, the pulse laser 108 is configured to translate or to rotate or turn about its own axis, or in an opposite or reverse direction in the axis that is generally perpendicular to a longitudinal axis of the fibre.

It will be appreciated by a person skilled in the art that the embodiment of FIG. 1 can be applied to any type of system that may process a fibre. Furthermore, it is apparent to a person skilled in the art that there are various ways to configure the system 100 to achieve the above-mentioned technical function (e.g., such that providing a fibre via the preform 104 is accompanied with a corresponding movement of the pulse laser 108). However, it will be appreciated to a person skilled in the art that the present invention is not limited to the specific configurations described hereinafter and other configurations and types of system are within the scope of the present invention so long as they are configured to achieve the same or equivalent technical function. For example, a person skilled in the art will understand that the system is configured to (i) obtain an integration of a plurality of fibre devices (or a dense integration of fibre devices) or (ii) process the fibre in a continuous manner while translating the fibre in a high volume fibre translation system.

Further, it will also be appreciated by a person skilled in the art that the embodiment of FIG. 1 is based on an integration of a femtosecond pulse laser system to a high volume fibre translation system, commonly but not limited to, a fibre draw tower or a fibre spooler (rewinder). For illustration purposes, the embodiment of FIG. 1 shows an integration of an ultra-short pulse laser 104 for fibre processing and fibre device fabrication into a fibre draw tower system.

The high spatial resolution (or sub-diffraction limit) index modification based on pulse light 108 interaction with the fibre material via the preform 104 advantageously allows point-by-point fibre grating inscription which leads to fabrication of fibre grating of an arbitrary length. Also, fibre grating structures are achievable for different operational wavelengths in any range of industrial interest e.g., from UV to IR regime. It is also possible to alter a refractive index, grating periodicity (e.g., spacing or separation between two adjacent gratings) and spatial profiling of the fibre fabricated by the embodiment shown in FIG. 1 so to achieve device spectral, polarization and temporal responses tailoring for different applications.

The embodiment of FIG. 1 takes advantage of the process and merits relating to ultra-short pulse laser-induced index modification in optical fibres. For example, by virtue of the non-linear, multi-photon laser-induced index modification process achievable in the femtosecond laser inscription, the fabrication methodology here will be independent of the host fibre material. Also, advantageously, the fibre fabricated by such fabrication methodology features desirable physical performance properties including high thermal resistance without post-inscription treatment required as the laser-induced change is structural (e.g., altering structure of the light transmissive core and/or the cladding material).

In a preferred embodiment, the pulse light 108 includes a robust single focusing lens optical inscription arrangement which does not include a phase mask or a complex, environmental-susceptible interferometry setup. The ultra-short and intense (e.g. TWcm-2) laser pulse interacts with the fibre dielectric material via the nonlinear photoionization mechanism, inclusive of the multi-photon absorption and the avalanche ionization. This eliminates the need for glass photosensitivity as compared to a conventional UV-laser based fibre processing of the inscription method. Advantageously, the femtosecond laser technology can achieve fibre device fabrication that is independent of fibre material (or fibre material agnostic). More importantly, the index modification induced by the laser is irreversible and hence the structures of the fabricated fibre devices will exhibit thermal resilience similar to that of UV-induced type fibre grating devices.

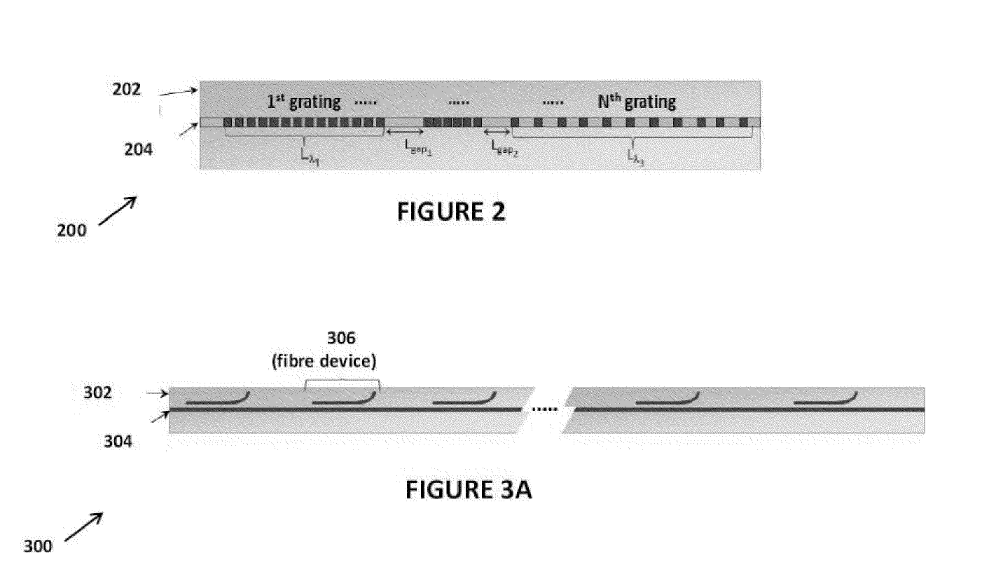

FIG. 2 depicts a simplified diagram illustrating complex structures (or gratings or waveguides) that are achieved in the fibre 200 according to the embodiment shown in FIG. 1. FIG. 2 shows a fibre 200 having a fibre cladding 202 and a fibre core 204. A first set of gratings can be achieved in the fibre core 204 having a length, L_{λ1}. A subsequent set of gratings can also be achieved in the fibre core 204 and separated from the first set of gratings by a gap, L_{gap1}.

It will be appreciated by a person skilled in the art that the method of fibre grating inscription shown in FIG. 1 is based on a point-by-point inscription technique where each laser pulse constitutes a grating period. In order to carry out the fibre grating inscription in this manner, pulse energy of the system 100 will be on the order of a few micro-joules. For example, a person skilled in the art will understand that in order to achieve a refractive index modulation of ˜10″3, the pulse energy should be in the order of 200 nano-joules. Further, it will also be understood that the pulse energy that is deposited into the fibre 200 during the inscription can be varied through an external optical attenuator. The pulse width of the laser will be on the order of 150 to 400 femtosecond, well below the electron-phonon scattering time (˜1 psec) of fibre dielectric materials. The femtosecond pulse characteristics will be registered real-time on a power meter (for pulse energy monitoring), an auto-correlator (for pulse width monitoring) as well as a spectrometer (for spectral width monitoring) to ensure constant laser inscription parameters.

For example, for a constant fibre translation speed and a fixed femtosecond laser pulse repetition rate, the grating pitch inscribed into the fibre under a constant axial tension can be expressed by A which is given by A=o/R, where o denotes the fibre translation speed in metres/sec and R denotes the repetition rate of the incident femtosecond pulse in Hz. For a femtosecond laser system operating with a tuneable repetition rate of kHz to 1 MHz, the resultant grating pitch achievable can range from <0.2 μm to several μm corresponding to achievable operation Bragg reflection wavelength encompassing the UV to IR regime.

By suitably controlling the incident femtosecond laser pulse repetition rate in the inscription process, arbitrary grating pitch, hence grating operation wavelength can be achieved on-the-fly. The lengths of the gratings inscribed as well as the positions of the grating structures in the fibre 200 are simply determined by the exposure intervals controlled through, for example a laser shutter. Advantageously, continuous grating or grating arrays of arbitrary lengths and operation wavelengths can be achieved in this technology as illustrated in fibre 200 in FIG. 2.

It will be appreciated by a person skilled in the art that the point-by-point grating inscription technique adopted in FIG. 1 adopts a single, high numerical aperture (NA), long-working distance objective lens to focus the ultra-short pulse laser beam into the fibre 200. Without the need of phase mask or interferometry optical setup to achieve grating fabrication, the optical inscription arrangement, according to embodiments of the invention, can be robust against environmental perturbations (e.g., variations in the airflow). Variation to the incident pulse energy can be achieved through an optical attenuator in the delivery path of the laser beam, allowing refractive index profiling in the resultant grating structure during the inscription process.

Further, it will also be appreciated by a person skilled in the art that the embodiment of FIG. 1 allows the tight focusing of the femtosecond laser pulse 108 into the fibre 200 which confines a region of laser-induced index change within the focal volume. By virtue of the nonlinear absorption and the ultra-short interaction between the incident pulse and the material at the focal volume, the effective size of laser-induced modifications can be smaller than the diffraction limit imposed by the objective lens and can have a cross-sectional area that is smaller than the focal volume. With precision translation through micro-actuators affixed to the objective lens, sub-micrometer spatial resolution control of the transverse location of the inscribed grating structure can be achieved.

A person skilled in the art will understand that the resultant fibre grating period inscribed relates to the laser repetition rate as well as the translation velocity of the fibre in the inscription process. To facilitate accurate grating period control over long lengths of fibre, a person skilled in the art will understand that synchronization should be ensured between the two parameters to minimize phase errors in the resultant fibre grating structures. Two approaches can be applied to ensure constant, synchronous operation of the laser pulse repetition rate to the translating fibre even at high velocity (10 s metres/sec).

For example, a first approach in a femtosecond pulse laser system includes a femtosecond pulse oscillator coupled to a regenerative amplifier (RA). The output repetition rate of the system is largely determined by the regenerative amplifier. According to an embodiment of the invention, an external input signal can be used to trigger the RA, which involves an onset of oscillator pulse input and amplification, followed by ejection of the amplified pulse. As such, an external input signal frequency (tens of kHz to 1 MHz) can be used to determine the output pulse repetition rate of the femtosecond laser system. This approach allows changing of the femtosecond laser repetition rate in frequency steps that is a function of the oscillator period. This usually translates to <0.1% frequency step change at 100 kHz repetition rate, and to 1% at 1 MHz repetition rate.

It will be appreciated by a person skilled in the art that in order to allow the femtosecond pulse laser to achieve high resolution and continuously variable output repetition rate, particularly at high frequency, oscillator cavity length tuning through a piezo-actuated end cavity mirror can be incorporated to continuously vary the oscillator period. This means of altering the oscillator period (e.g., available in commercial oscillator system for synchronization to an external clock) will allow effective analogue frequency control over a range of >1 kHz at a high output repetition rate of 1 MHz.

Further, it will also be appreciated by a person skilled in the art the required trigger signal can be derived accurately from the fibre translation system control which reads fibre translation speed to a resolution better than 1 mm/min. A person skilled in the art understands that by applying modulation to the repetition rate of the laser system during the inscription process, arbitrary chirped fibre grating structures can also be effectively obtained.

For example, for a second approach, a translating optical delay line arrangement can be built into the delivery path of the optical inscription setup. The required translation stage in the delay line setup will have a travel range of ˜±10 mm with nanometre positioning accuracy and resolution. For a fibre translation speed variation of a reasonable speed, for example, 10 mm/min, the required rate of optical path compensation will be on the order of <tens of nm/sec for incident femtosecond pulse tram repetition rate ranging from tens of kHz to 1 MHz. Commonly available flexure piezo-actuators will be employed to achieve the required continuous delay path compensation. Similarly, the required translation velocity control of the delay line can be derived accurately from the fibre translation system to a resolution better than 1 mm/min.

The method of grating inscription based on ultra-short pulse laser induced modification of fibre represents a simple, mask-less, single-step approach towards high-volume, direct processing of optical fibres in translation. Advantageously, the proposed integration of femtosecond pulse laser technology to a high-volume translating fibre system according to embodiments of the invention provides attractive extensions of such laser processing and includes rapid generation of high-volume distributed complex structures (e.g., optical and opto-fluidics in fibres) and structural modifications of long lengths of fibres.

According to an embodiment of the invention, for an effective single-pulse laser-induced modified region of diameter φ within the fibre, geometrically continuous laser-induced modifications can be achieved in the fibre when the fibre translation speed with respect to the laser repetition rate is given by υ/<<φ, where υ denotes the fibre translation speed in metres/sec and R denotes the repetition rate of the incident femtosecond pulse in Hz. A person skilled in the art understands that incorporating such inscription process into a continuous long-length fibre translation system in an embodiment enables rapid, distributed generation of complex laser-induced modifications. A conventional technique which only applies a preform, without a translation system according to the present invention, cannot achieve such advantages.

Advantageously, the fabrication methods according to embodiments of the invention leverage on the high spatial resolution inscription achievable to attain a distributed, dense integration of optical device structures/components/circuits within the fibre core and the cladding. Through the laser induced inscription of waveguide structures within the fibre cladding in proximity of the fibre core, waveguides or optical couplers can be distributed along continuous, long-lengths of fibres to out-couple a designed amount of core-propagating light along the fibre. The out-coupling ratio can be tuned by controlling the inscribed waveguide parameters as well as the separation between the waveguide and the fibre core.

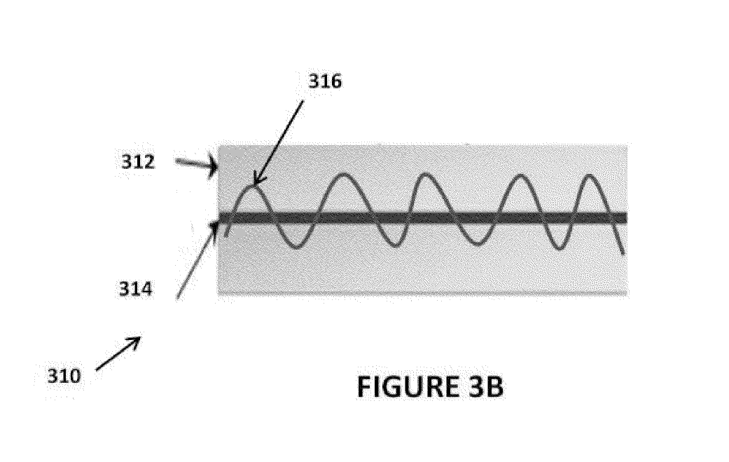

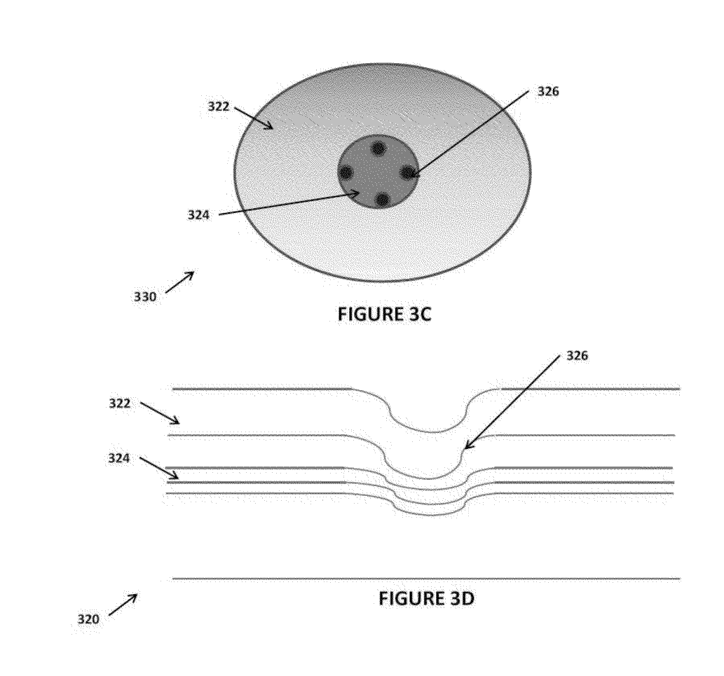

FIG. 3A depicts a simplified diagram illustrating distributed waveguides in the fibre according to the embodiment shown in FIG. 1. FIG. 3A shows a fibre 300 having a fibre cladding 302 and a fibre core 304 and at least one structure (waveguide or output coupler or tap or optical splitter) 306 is inscribed on the fibre cladding 302 and along the longitudinal axis of the fibre core 304. The waveguide 306 is an example of a fibre device. As previously stated, a fibre device is understood to be a modification done on the fibre.

Referring to FIG. 3A, according to an embodiment of the invention, the waveguide 306 is inscribed on the fibre cladding 302 such that one portion of the waveguide 306 is nearer to the fibre core 304 than another portion of the waveguide 306. The portion of the waveguide 306 that is nearer to the fibre core 304 is able to interact with the light and the portion of the waveguide 306 that is further away from the fibre core 304 avoids or does not permit any interaction with the light propagating the core. Advantageously, the creation of continuous or distributed waveguide structures in the fibre cladding 302 at a designed, close proximity to the fibre core 304 can also effectuate high-order mode discrimination in large-core gain fibres, commonly used in high power fibre amplifiers and lasers.

A person skilled in the art will also understand that it is possible to inscribe a waveguide in a manner that at least a portion of the waveguide extends through the cladding material and the fibre core. In an embodiment, the cladding material may be grated to inscribe at least one waveguide which passes through the cladding material. The waveguide may also have a portion that passes transversely through the core. In another embodiment, it is possible to inscribe a waveguide 316 that is spiral around the fibre core 304, as shown in FIG. 3B. FIG. 3B shows a fibre 310 having a fibre cladding 312 and a fibre core 314 having at least one waveguide inscribed on the fibre cladding 312 and around the fibre core 314.

In another embodiment, the structure of the fibre core is altered in order to sense pressure, for example by inscribing at least two additional gratings in the fibre core. FIG. 3C shows a fibre 320 having a fibre cladding 322 and a fibre core 324 having four gratings 326 inscribed in the fibre core 324. The four gratings 326 are inscribed in a circumferential manner in the fibre core 324 to sense pressure and direction of pressure.

FIG. 3D depicts a simplified diagram of FIG. 3C. A person skilled in the art will also understand that two gratings 326 can be inscribed in the fibre core 324 in order to sense airflow. A person skilled in the art will also understand that it is possible to alter the fibre core 324 at least twice, e.g., inscribe at least two gratings 326 in the fibre core 324, so as to sense airflow. FIG. 3D shows a fibre 320 having a fibre cladding 322 and a fibre core 324 and gratings 326 are inscribed in the fibre core 324. In an embodiment, the gratings 326 move towards one another when pressure or airflow is detected. As shown in FIG. 3D, the pressure causes the cladding material 322 to move towards the fibre core 324 which in turn causes the gratings 326 to move towards one another.

Inscribed structures 306, 316 and 326 allow monitoring of various properties, such as spectral characteristics and power of the light propagating the fibre core 304, 314 and 324. Using a conventional approach, it is necessary to spin the fibre preform during the fibre drawing process in order to generate a satellite waveguide in close proximity to the fibre core. The fabrication technology according to embodiments of the invention allows multi-dimensional customization and real-time adjustment of satellite waveguides fabricated in close proximity to the fibre core and within fibres of any material and geometry.

Further advantageously, the fabrication technology according to embodiments of the invention allows fabrication of waveguides within long lengths of fibre of any material and geometry to impose high extinction ratio polarization discrimination (or low polarization cross-talk between fibres) to the core-propagating light, leading to single polarization light transmission fibres. This is in contrast to the conventional approach which causes losses of high birefringence fibres (where birefringence is an optical property of a material having a refractive index that depends on polarization and propagation of light). Advantageously, the fabrication methodology according to embodiments of the invention provides fibre devices that can perform robust, straightforward operation with high polarization extinction ratio.

The fabrication methodology according to embodiments of the invention enables various other forms of passive component structures including resonators and interferometers to be distributed within long lengths of the fibre. The technology can provide an effective means to alter the transmission characteristics of the fibre which otherwise cannot be achieved based on its intrinsic fibre preform design. Advantageously, the embodiments according to the invention will not compromise the pristine mechanical strength of the fibre itself and the embedded optical components along the lengths of the fibre offer the practical advantages such as ease of fibre coupling as well as packaging desired for applications.

The fabrication methods according to embodiments of the invention enable rapid generation of large distribution of fibre components to provide advanced functionalities in fibres which otherwise cannot be achieved based on its intrinsic fibre preform design. Formation of optical circuits directly within the optical fibre opens new prospects for manufacturing compact and functional optical microsystems for telecommunication, sensing and lab-in-fibre applications. For example, the structure of the fibre core can be altered so as to sense temperature, pressure or control polarization. In an embodiment, the fibre core can be altered twice to sense airflow, as shown in FIG. 3D above. The concept extends to generating large distribution of integrated opto-fluidic micro-channels within the fibre, in particular, the use of ultrafast laser can either (a) perform direct ablation on designated sections of the translating fibre or, (b) a 2-step process of laser inscription followed by chemical-assisted etching process.

The integration of ultrafast pulse laser technology to high-volume fibre translation systems such as that of a fibre draw tower or a fibre spooler can enable high volume generation of such opto-fluidic fibres for various optical manipulation and sensing applications. The introduction of index modification within the propagating core of the fibre can enable new operational properties of the fibre which otherwise cannot achieve based on its intrinsic fibre preform design. These include altering the birefringence of the fibre, altering the mode field diameter and altering the spatial position of the core propagating mode. The integration of ultrafast laser inscription technology into high-volume translating fibre system herein enables both continuous long-length fibre structure modifications as well as sectional, localized customizations. Similarly, the methodology herein is independent of fibre material. Applications such as remote optical sensing applications can leverage on such capabilities during fibre production.

Examples of fibre structural modifications include:
The introduction of regions of higher refractive indexes within the fibre core to translate the core mode field distribution, leading to higher field intensity outside the core.
The introduction of higher birefringence in fibres by making transverse asymmetric index modifications along the core of the fibre.
The introduction of ultrafast laser-induced material modifications in fibres by having stress-induced regions alleviate undesirable stimulated Brillouin scattering. For example, Brillouin scattering causes an index of refraction of a fibre to change and can be alleviated by inducing laser-induced stress within the fibre so as to cause disturbance between the acoustic and optical mode within the fibre (or time-and-space-periodic variations in the fibre).

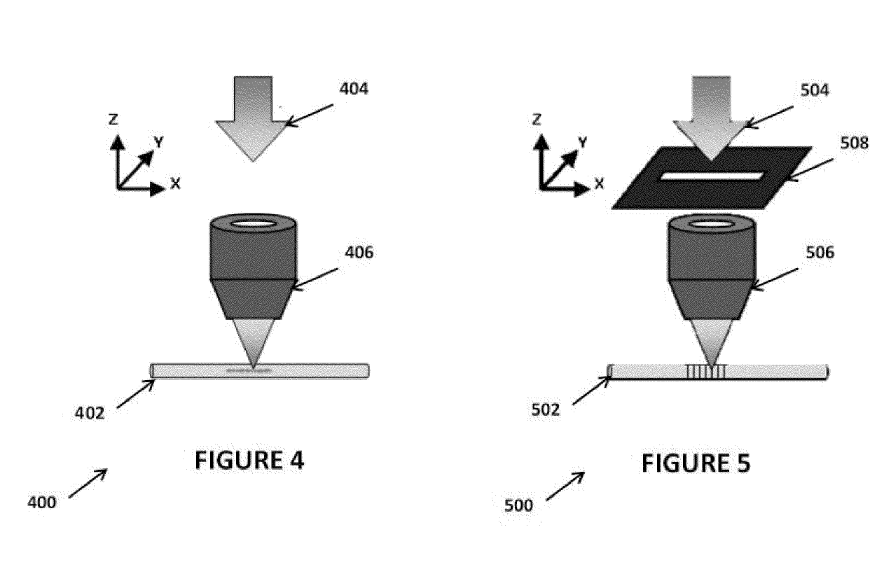

FIG. 4 depicts a simplified diagram illustrating how to perform laser inscription according to a conventional technique. The system 400 comprises a fibre 402, a laser beam 404 and an objective lens 406. The laser beam 404 propagates through the objective lens 406 before interacting with the fibre 402 so as to inscribe the fibre 502. However, it is difficult or even impossible to inscribe the fibre 402 without any distortion by the conventional technique. One of the reasons is due to the fact that the fibre has an intrinsic cylindrical geometry which will distort the optical electromagnetic energy (e.g., the laser beam 404 that incident on it).

On the other hand, embodiments of the invention do not have this problem. For example, in one embodiment, the system illustrated in FIG. 1 relies on tight focusing of the ultrafast laser pulse into the fibre to achieve laser-induced refractive index change. The required tight focusing can be attained through a commercially-available NIR-corrected long working distance objective lens. To overcome the beam distortion induced by the intrinsic curvature of the fibre geometry, the fibre can translate through a customized square capillary confinement containing index matching fluid (e.g. glycerin) such that the surface geometry presented to the path of the incident femtosecond laser beam is flat.

This embodiment, which can be understood to be similar to the use of an oil-immersion lens (working distance of <500 μm), offers greater fabrication flexibility and ease of implementation. The dry objective lens (NA of −0.55) will have a working distance of >5 mm, allowing a large translation working distance, hence a large inscription region within the fibre. Alternatively, or additionally, the system illustrated in FIG. 1, can also adopt suitable beam profiling such as the example shown in FIG. 5.

FIG. 5 depicts a simplified diagram illustrating how to perform laser inscription according to an embodiment of the present invention. The system 500 comprises a fibre 502, a laser beam 504, a slit 508 and an objective lens 506. The laser beam 504 propagates as optical electromagnetic energy through the objective lens 506 via the slit 508 before interacting with the fibre 502 so as to advantageously inscribe the fibre 502. In an embodiment shown in FIG. 5, the system 500 can adopt suitable beam profiling such as a slit shaping 508 that is positioned prior to the objective lens 506 to compensate or alleviate optical distortion (that may be induced by the fibre geometry) to the incident femtosecond laser beam. A person skilled in the art will appreciate that it is possible to modify the system 500 to be specific for different fibre geometries, for example, adopting a slit having a different geometry that is better suited to compensate the optical distortion induced by the fibre geometry.

In one embodiment, the high NA focusing objective lens for incident beam focusing, coupled with a long focal length (180 mm) tube lens can simultaneously form a necessary high magnification (>60×) infinity-corrected optical vision system for real-time monitoring of the inscription process. The field of view of the vision system will be approximately 60 μm by 60 μm allowing detail view of the fibre core 502. High speed image processing in the form of edge detection of the boundaries of the fibre core 502 will serve to define the inscription region of the fibre core 502 and hence facilitate positional feedback to the inscription system 500.

In one embodiment of the invention, additional monitoring of a focused beam positioning within the fibre can be achieved through measuring the residual incident femtosecond beam transmitted through the fibre using a photo-detector array. The residual inscription laser transmitted transversely through the fibre (for example, 200, 300) will be diffracted as a result of the geometry of the optical fibre. For a well-centred incident beam targeted at the centre of the fibre core, the residual diffracted optical transmission profile of the laser will be symmetric about the fibre position. Taking into consideration the mechanical dynamics of the fibre in translation, in a fibre draw tower or a fibre spooler, various physical modifications can be made to further assist the accuracy and stability of the focusing of the pulse laser beam 108 into the fibre (for example, 200). For example, the fibre translation system may include tension monitoring load cells, line speed and fibre tension control. In order to further assist the accuracy of the focusing of the pulse laser beam into the fibre, the fibre translation system will make the necessary adjustments so as to achieve a stable, well-centred translating fibre. In an embodiment, tension imposed may be in the range of 50 g to 400 g force. The translation speed of the fibre will be accurately monitored to a resolution of <1 mm/min. The inclusion of v-groove guide wheels as well as apertures can further restrict the maximum deviation of the fibre with respect to the position of the inscription pulse laser beam.

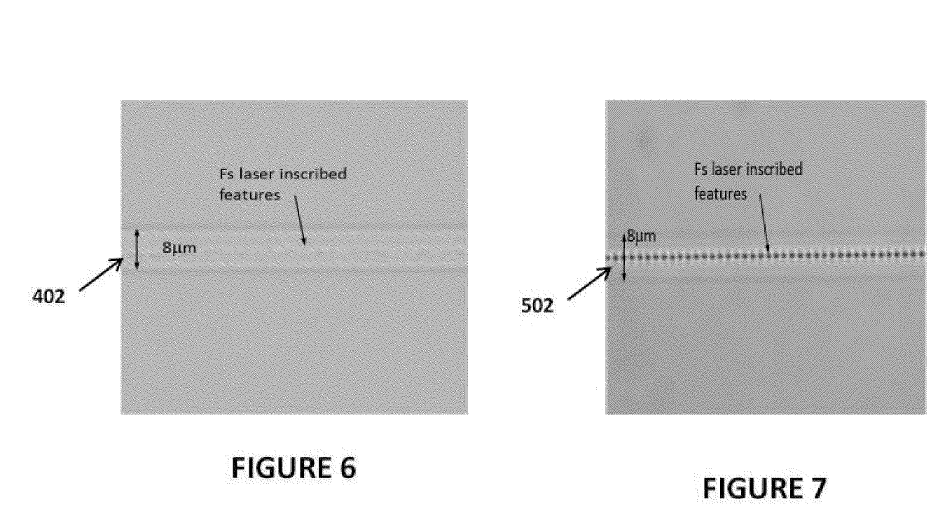

FIG. 6 depicts a sample grating result achieved on the fibre according to the conventional technique shown in FIG. 4. Referring to FIG. 6, the fibre core 402 is shown having low fidelity grating inscriptions, along with distortions when the convention technique shown in FIG. 4 is applied.

FIG. 7 depicts a sample grating result achieved on the fibre according to the embodiment shown in FIG. 5. Referring to FIG. 7, the fibre 502 is shown having high fidelity, low order grating inscriptions without distortions when an embodiment of the invention shown in FIG. 5 is applied. It is apparent to a person skilled in the art that there are various ways to configure the technique to achieve the same above-mentioned technical function (e.g., making high fidelity grating inscriptions on the cladding material (302 as shown in FIG. 3A).

Advantageously, embodiments of the invention allow the fibre processing process to be carried out on a coated fibre. By virtue of the non-linear laser-induced index modification process in the fibre, material modification occurs only at the focal point of the beam where sufficient accumulation of laser intensity is achieved. The process advantageously reduces damage, for example it reduces heat damage around the modification because the modification only occurs at the focal point of the beam. Additionally, this advantageously overcomes many shortcomings of the conventional polymer coating process. For example, the conventional polymer coating process does not possess significant linear absorption at the wavelength of infrared femtosecond laser. Also, for the conventional polymer coating process, the intensity of the incident beam away from the focus point of a high NA focusing objective lens may be insufficient to reach the damage threshold of the polymer. On the other hand, embodiments of the invention allow fibre processing and device fabrication to be carried out after the coating process. This advantageously retains pristine fibre mechanical strength and physical integrity, thereby allowing minimal modification to a commercially-available fibre translation system, e.g., the fibre draw tower.

On a fibre draw tower system, embodiments of the inventions can be applied prior to the fibre coating process, particularly where non-conventional polymer material which exhibits partial or high absorption at the inscription laser wavelength. By fabricating the fibre device prior to the fibre coating process allows the fibre to retain its mechanical strength and avoid unnecessary damage, thereby preserving the integrity of the coating layer. Alternatively, or additionally, with direct access to the drawn fibre, extensive femtosecond laser-induced micro-inscription can be performed freely both within the core and the cladding without concerns over undesirable damage to the cladding-coating interface. For example, embodiments of the invention allow laser-induced index modifications to be done within the fibre at elevated temperatures, thereby reducing the concern over the thermal resistance of coating material. Advantageously, such index modifications introduce a mechanical stress region around the volume. The mechanical stress region may be relaxed with thermal conditioning, leading to higher index modulation and fibre grating reflectivity. Such stress relaxation of laser-modified region will lead to higher index modulation, hence fibre grating reflectivity.

It will be appreciated by a person skilled in the art that numerous variations and/or modifications may be made to the present invention as shown in the specific embodiments without departing from the scope of the appended claims as broadly described. The present embodiments are, therefore, to be considered in all respects to be illustrative and not restrictive.

What is claimed is:

1. A method of fabricating a fibre device; the method comprising:
translating a fibre having a light transmissive core surrounding by a cladding material; and,
while translating, non-interferometrically applying energy to alter structure of the light transmissive core and/or the cladding material.

2. The method according to claim 1, wherein the step of applying energy further comprises applying a pulse light.

3. The method according to claim 1, wherein the step of applying energy further comprises applying a focused light.

4. The method according to claim 1, wherein the structure of the core is altered to alter properties of a light transmitting the core.

5. The method according to claim 4, wherein altering the properties of the light includes at least one of removing a wavelength of the light, polarizing the light and filtering the light.

6. The method according to claim 1, wherein the structure of the light transmissive core is altered to sense temperature.

7. The method according to claim 1, wherein the structure of the light transmissive core is altered to sense pressure.

8. The method according to claim 7, wherein the structure of the light transmissive core is altered at least twice to sense airflow.

9. The method according to claim 1, wherein the structure of the light transmissive core is altered to control polarization.

10. The method according to claim 1, wherein the step of applying energy to alter structure of the light transmissive core includes altering a refractive index of the core so as to alter an index profile.

11. The method according to claim 1, wherein the step of translating the fibre includes inscribing at least one grating in the core.

12. The method according to claim 1, wherein the step of translating the fibre includes modifying the cladding material to inscribe at least one additional waveguide, the at least one additional waveguide being spiral around the core.

13. The method according to claim 12, wherein the at least one additional waveguide is inscribed along a longitudinal axis of the core.

14. The method according to claim 1, wherein the step of translating the fibre includes modifying the cladding material to inscribe at least one additional waveguide, the at least one additional waveguide being inscribed such that one portion of the at least one additional waveguide is nearer to the core than another portion of the at least one additional waveguide, wherein the one portion of the at least one additional waveguide is able to interact with the light and the another portion of the at least one additional waveguide avoids interacting with the light propagating the core.

15. The method according to claim 1, wherein the step of translating the fibre includes modifying the cladding material to inscribe at least one additional waveguide, the at least one additional waveguide being inscribed through the cladding material and transversely through the core.

16. The method according to claim 11, wherein the grating is a Fibre Bragg grating (FBG).

17. The method according to claim 1, wherein the method is fibre material agnostic.

18. The method according to claim 1, wherein the step of applying energy comprises applying optical electromagnetic energy through a slit.

19. The method according to claim 1, wherein the method is adapted to obtain an integration of a plurality of fibre devices while translating the fibre in a high volume fibre translation system.

20. The method according to claim 1, wherein the method is adapted to process the fibre in a continuous manner while translating the fibre in a high volume fibre translation system.
